(19) United States
(12) Patent Application Publication
(10) Pub. No.: US 2004/0130210 A1
(43) Pub. Date: Jul. 8, 2004

(54) Method for improving control behavior and stability under a thermal load of an automotive control system

(76) Inventors: Peter Wanke, Frankfurt (DE); Rainer Klusemann, Frankfurt/M (DE); Torsten Herrmann, Frankfurt/Main (DE); Christof Schutz, Florsheim (DE); Artur Kost, Bad Soden (DE)

Correspondence Address: Gerlinde M. Nattler, Continental Teves, One Continental Drive, Auburn Hills, MI, 48326, US

(21) Appl. No.: 10/473,535

(22) PCT Filed: Mar. 28, 2002
(86) PCT No.: PCT/EP02/03530

(30) Foreign Application Priority Data
Mar. 28, 2001 (DE) 101 15 550.6

(51) Int. Cl. B60T 8/32

(52) U.S. Cl. 303/191

(57) ABSTRACT

The present invention relates to a method for improving the control behavior and stability under a thermal load of an automotive vehicle control system with brake intervention, such as TCS, BTCS, ESP, etc. In order to reduce the thermal stress on the brake system in a control system without engine interface, some of the control functions that may involve critical thermal loads on the brake system are at least temporarily disabled or allowed only to a limited extent in defined control situations.

### BACKGROUND OF THE INVENTION

The present invention relates to a method for improving the control behavior and stability under a thermal load of an automotive vehicle control system with brake intervention, such as TCS, BTCS, ESP, etc.

Brake and engine intervention are the basic adjustments possible in current ESP systems. Many up-to-date series vehicles, however, have no or only an insufficient engine torque interface (possibility of taking influence on the engine torque and feedback of the actual value) so that engine intervention cannot be performed at all or only with limited efficiency. To offer a control system that enhances stability and traction also to these vehicles, suggestions are made to derive a control system without engine intervention from the existing ESP/TCS. According to nature, the result is a loss in function with respect to steerability, stability, and traction, with these qualities being, however, considerably improved compared to the pure ABS system.

The major problem involved in a control system without traction control/engine torque control is the much higher thermal stress the friction pairing of the brake is exposed to, which can cause loss of the braking effect at the wheel concerned and/or a considerably greater wear in extreme cases. The increased thermal stress for the wheel brakes of the driven axle is produced because only brake intervention is able to restrict the consequences of an engine torque selected at too high an amount.

Therefore, problems will be encountered in all situations in which an excessively highly predetermined engine torque represents the cause for loss of stability, steerability, or traction of the vehicle. Thus, brake intervention can reduce e.g. excessive slip in the driveaway range for achieving increase in traction, can prevent the loss of lateral stability due to excessive slip and consequently arising instability, or moderate understeering instability due to non-adapted speed. However, in neither of the mentioned cases is it possible to reduce the engine torque and, hence, eliminate the cause for the introduction of energy into the system. The result is that brake intervention must be active for a considerably longer period of time and at a higher braking pressure level, applying higher thermal stress to the friction pairing.

One possibility of preventing the risk of thermal overload is drafting a model for the temperature stress on the brakes and disabling the control system when a limit temperature is reached. This procedure represents a technical standard in brake control of TCS (TCS=Traction Slip Control). If said procedure was transferred unmodified to the control system without engine interventions, the availability of the overall control system would be greatly limited due to the above-mentioned increased thermal stress of the brakes. Increasing the limit temperature would however imply the risk of thermal overload of the brakes, what renders the conflict of goals in system design apparent.

In view of the above, an object of the invention is to overcome the described difficulties.

### SUMMARY OF THE INVENTION

It has been found out that this object may be achieved in that in defined control situations partial ranges of the control functions which leave to expect critical thermal stress on the brake system are at least temporarily disabled or allowed only within limits to reduce the thermal stress on the brake system.

Advantageously, the method for improving the control behavior and stability under thermal load of an automotive vehicle control system with brake intervention, such as TCS (traction slip control), BTCS (brake intervention for traction slip control), ESP (electronic stability program) etc., which has no interface, arranges for partial ranges of the control functions which lead to expect critical thermal stress on the brake system to be at least temporarily disabled or allowed only to a limited extent in order to reduce the thermal stress on the brake system in certain control situations. A method has shown as especially appropriate in an ESP automotive vehicle control system, which temporarily disables or restrictedly allows the partial function of a traction slip control system depending on whether or not ESP control follows traction slip control.

To reduce the thermal stress of the brake system, it is expedient to allow at least temporarily only EDS (electronic differential lock) functions, meaning traction improvement by brake intervention at one wheel of an axle, in a traction slip control by brake intervention (BTCS) in determined situations, such as in the driveaway range at homogeneous coefficients of friction, during stable cornering maneuvers, etc. The basis for an EDS function normally is a roadway with different skid conditions, i.e., a different adhesion coefficient potential on the right-hand or left-hand drive wheel (so-called μ-split). As this occurs, the traction force that is possible on the non-skid side of the roadway cannot be utilized. The cause for this condition is the differential between the two driven wheels in which, due to the function as torque balance, the side with the lower drive torque determines (or limits) the torque on the opposite side. EDS (electronic differential lock) will adaptively intervene into the brake when a drive wheel starts to spin and, as a result, acts similarly compared to a differential lock, and increases traction. The brake torque produced acts as an additional support on the differential and, hence, is available as a drive torque on the opposite wheel. This increase in traction has an effect above all in the low speed range of the vehicle so that thermal stress of the brake system will occur within admissible limits. As this occurs, preferably the EDS function is allowed temporarily when no ESP driving stability control follows traction slip control.

Favorably, it is determined upon entry into traction slip control whether a tendency to a subsequent unstable cornering maneuver can be concluded from the steering angle, and/or the yaw rate, and/or the transverse acceleration, or from the control difference between the ESP yaw rate control and/or sideslip-angle speed difference control, and in this case brake intervention at both wheels (BTCS) is allowed in traction slip control. It is furthermore favorable that in an unstable cornering maneuver (ESP control) brake intervention on both wheels (BTCS) is allowed in traction slip control. With these measures, brake pre-intervention is achieved already when a ‘driving behavior’ prevails which ESP control considers stable, on the one hand. On the other hand, the vehicle speed is reduced and/or the stability of the vehicle increased during unstable cornering maneuvers by way of the allowed actuation of the two wheel brakes.

It is advantageous that in situations critical for driving stability the full control functions are only allowed as long as a limit temperature of the system, which is determined by measurement or temperature model calculation, has not been reached.

Thus, the invention represents a solution in the above-noted conflict. In principle, the solution involves deliberately doing without partial ranges of the control functions in determined condition ranges for the reduction of the total thermal load in order to increase the availability of the overall system for other partial functions. As an embodiment of this basic idea, it is suggested managing without the traction characteristics in favor of an enhanced availability of the stabilization features of the overall control system.

High wheel slip values are known to occur especially in the driveaway range on low coefficients of friction (Lμ) due to low applicable wheel torques, said wheel slips being encountered on both vehicle sides with homogeneous friction coefficient conditions. Principally, TCS has two control variants. On the one hand, this is the so-called EDS (electronic differential lock), which according to the naming of this system, is only capable of eliminating differential slip between the two vehicle sides. On the other hand, BTCS (Brake Traction Control System) is able to regulate also wheel slip that is encountered on both vehicle sides in addition to the above differential slip. Thus, BTCS will become active mostly in the driveaway range with homogeneous friction conditions, i.e., the control system will in first line improve the traction features of the vehicle in this case. When the vehicle is on Lp in a cornering maneuver, especially with a mere rear drive of the vehicle, spinning of both rear wheels can cause the total loss of the lateral stability properties of the vehicle and thus an unstable oversteering condition, which subsequently even the oversteering intervention of ESP at low coefficients of friction is unable to overcome.

### DETAILED DESCRIPTION OF AN EXAMPLE

The present invention discloses enabling only one EDS system in the driveaway range for limiting thermal stress. Only when it is ensured by a detection system that a yaw-dynamics situation is likely to follow, has already announced its arrival, or is prevailing will the full BTCS with a brake intervention on possibly both sides be allowed. Thus, BTCS would be operable as sort of a pre-intervention for the classical ESP brake intervention.

The above-mentioned findings can manifest themselves in the following manner:

a) A situation critical under yaw-dynamics aspects is possible:

In this case the steering angle and/or the yaw rate and/or the transverse acceleration must exceed defined threshold values.

b) A situation critical under yaw-dynamics aspects is about to happen:

The control difference of the ESP yaw rate control (Δ\dot{ψ}) and/or sideslip-angle speed control (Δ\dot{β}) exceeds a certain portion k, wherein k>0 and k<=1, of the respective entry thresholds of the control components (\dot{ψ}_{threshold} or \dot{β}_{threshold}) i.e. Δ\dot{ψ}=\dot{ψ}_{actual}−\dot{ψ}ₙₒₘᵢₙₐₗ>k*\dot{ψ}_{threshold} or Δ\dot{β}=\dot{β}_{actual}−\dot{β}ₙₒₘᵢₙₐₗ>k*\dot{β}_{threshold} It could be possible to reset the detection system when values fall under a certain part of the exit threshold of the mentioned control components if also an ESP control that became active, as the case may be, is terminated. The detection system becomes active when the bottom entry vehicle speed for the ESP is exceeded and must be disabled when the speed drops below the exit vehicle speed.

c) A situation critical under yaw-dynamics aspects is prevailing:

The ESP control system is active.

An extension of the described procedure of situation-selectively activating the complete BTCS could consist in that additionally the BTCS is also allowed in the driveaway range, unless a defined limit temperature Tₗᵢₘᵢₜ of the temperature model which lies below the mentioned disabling temperature Tₘₐₓ is exceeded. The above-described situation-responsive activation of the complete BTCS would apply above the bottom limit temperature. This possibility is denoted by configuration 2 in the following table. This procedure in steps would render it possible to enhance the availability of the traction features. It would be disadvantageous in this respect that the system availability is little distinct for the driver (reaching the bottom temperature limit).

| | Configuration | |
|---|---|---|
| Brake Temperature | 1 | 2 |
| T_{B} < Tₗᵢₘᵢₜ | | BTCS |
| Tₗᵢₘᵢₜ < T_{B} < Tₘₐₓ | a) full BTCS function | a) full BTCS function |
| | only for stabilization | only for stabilization |
| | b) EDS in all remaining | b) EDS in all remaining |
| | situations | situations |
| T_{B} > Tₘₐₓ | no EDS/BTCS | no EDS/BTCS |

1. Method for improving the control behavior and stability under a thermal load of an automotive vehicle control system with brake intervention, such as TCS, BTCS, ESP, etc.,
characterized in that in defined control situations partial ranges of the control functions which leave to expect critical thermal stress on the brake system are at least temporarily disabled or allowed only within limits to reduce the thermal stress on the brake system.

2. Method as claimed in claim 1,
characterized in that only EDS functions, i.e. traction improvement by brake intervention on a wheel of an axle, are allowed at least temporarily in traction slip control by brake interventions (BTCS) in defined situations such as in the driveaway range on homogeneous coefficients of friction, during stable cornering maneuvers, etc.

3. Method as claimed in claim 1 or 2,
characterized in that upon entry into traction slip control it is determined whether a tendency to a subsequent unstable cornering maneuver is concluded from the steering angle, and/or the yaw rate, and/or the transverse acceleration, and that in this case brake intervention at both wheels (BTCS) is allowed in traction slip control.

4. Method as claimed in any one of claims 1 to 3,
characterized in that that upon entry into traction slip control it is determined whether a tendency to a subsequent unstable cornering maneuver is concluded from the control difference between the ESP yaw rate control and/or sideslip-angle speed difference control, and that in this case brake intervention at both wheels (BTCS) is allowed in traction slip control.

5. Method as claimed in any one of claims 1 to 4,
characterized in that in an unstable cornering maneuver (ESP control) brake intervention at both wheels (BTCS) is allowed in traction slip control.

6. Method as claimed in any one of claims 1 to 5,
characterized in that in situations critical for driving stability the full control functions are only allowed as long as a limit temperature of the system that is determined by measurement or temperature model calculation has not been reached.
